(19) United States
(12) Patent Application Publication
(10) Pub. No.: US 2024/0098822 A1
(43) Pub. Date: Mar. 21, 2024

(54) ADAPTIVE CONFIGURATIONS IN A WIRELESS NETWORK

(71) Applicant: MAXLINEAR, INC., CARLSBAD, CA (US)

(72) Inventor: Guobing TAN, Dublin, CA (US)

(73) Assignee: MAXLINEAR, INC., CARLSBAD, CA (US)

(21) Appl. No.: 18/471,118

(22) Filed: Sep. 20, 2023

Related U.S. Application Data
(60) Provisional application No. 63/376,323, filed on Sep. 20, 2022.

(51) Int. Cl. H04W 76/15; H04L 5/00

(52) U.S. Cl. CPC H04W 76/15; H04L 5/0048; H04L 5/006

(57) ABSTRACT

A method includes obtaining a first characteristic associated with a wireless environment. The wireless environment may include at least a first device and a second device. The method may include automatically determine a mode of operation of the first device that may be based on the first characteristic. The method may include configuring an adaptive module in the first device to transmit data to the second device using the determined mode of operation. The method may also include transmitting the data from the first device to the second device using the adaptive module and the determined mode of operation.

### CROSS REFERENCE TO RELATED APPLICATIONS

This U.S. Patent Application claims priority to U.S. Provisional Patent Application No. 63/376,323, titled “ADAPTIVE MULTI-INPUT MULTI-OUTPUT WITH MULTI-LINK OPERATION,” and filed on Sep. 20, 2022, the disclosure of which is hereby incorporated by reference in its entirety.

### TECHNICAL FIELD

This disclosure generally relates to wireless communication systems, and more specifically, to adaptive configurations in a wireless network.

### BACKGROUND

Unless otherwise indicated herein, the materials described herein are not prior art to the claims in the present application and are not admitted to be prior art by inclusion in this section.

Home, office, stadium, and outdoor networks, a.k.a. wireless local area networks (WLAN) are established using a device called a Wireless Access Point (WAP). The WAP may include a router. The WAP wirelessly couples all the devices of the local network, e.g., wireless stations such as: computers, printers, televisions, digital video (DVD) players, security cameras and smoke detectors to one another and to the cable or subscriber line through which Internet, video, and television is delivered to the local network. Most WAPs implement the IEEE 802.11 standard, which is a contention-based standard for handling communications among multiple competing devices for a shared wireless communication medium on a selected one of a plurality of communication channels. The frequency range of each communication channel is specified in the corresponding one of the IEEE 802.11 standards being implemented, e.g., “a”, “b”, “g”, “n”, “ac”, “ad”, “ax”, “ay”, “be”. Communications follow a hub and spoke model with a WAP at the hub and the spokes corresponding to the wireless links to each ‘client’ device or station (STA) utilizing the WLAN.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

In an example embodiment, a method may include obtaining a first characteristic associated with a wireless environment. In some embodiments, the wireless environment may include at least a first device and a second device. The method may also include automatically determine a mode of operation of the first device that may be based on the first characteristic. The method may further include configuring an adaptive module in the first device to transmit data to the second device using the determined mode of operation. The method may also include transmitting the data from the first device to the second device using the adaptive module and the determined mode of operation.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates an example environment of wirelessly coupled devices and where one device may perform adaptive configurations;

FIG. 2 illustrates an example wireless device that supports adaptive configurations;

FIG. 3 illustrates an example wireless device that supports adaptive configurations;

FIGS. 4A and 4B illustrate example arrangements of a wireless device that supports adaptive configurations;

FIGS. 5A and 5B illustrate example arrangements of a wireless device that supports adaptive configurations;

FIGS. 6A and 6B illustrate example arrangements of a wireless device that supports adaptive configurations;

FIGS. 7A and 7B illustrate example arrangements of a wireless device that supports adaptive configurations;

FIG. 8 illustrates an example environment that supports adaptive configurations between a wireless device and multiple linked devices;

FIG. 9 illustrates an example environment that supports adaptive configurations between a wireless device and multiple linked devices;

FIG. 10 illustrates a flowchart of an example method of determining a configuration for a wireless device in a wireless network; and

FIG. 11 illustrates a flowchart of an example method of adaptive configurations in a wireless network.

### DETAILED DESCRIPTION

In wireless communications (such as WiFi), spectrum availability and/or channel availability may be dynamic and may depend on the environment where the wireless network is deployed and/or the demographics of the wireless client devices in the wireless network. For example, in crowded and/or dense population areas, spectrum and/or channels may become scarce resources and finding enough channels (e.g., channel availability) for wireless devices to operate efficiently may be difficult. In such instances, a multiple-input, multiple-output (MIMO) system (which may include a higher order MIMO) may improve and/or maximize throughput and/or may reduce interference, such as by implementing multi-user MIMO (MU-MIMO) systems, spatial diversity, and/or multiplexing.

Alternatively, or additionally, in sparse population areas, spectrum and/or channels may be more readily available. In such circumstances, multi-band operation and/or multi-link operation (MLO) may improve the aggregate throughput and may improve and/or maximize utilization of the spectrum and/or the channels.

Alternatively, or additionally, in circumstances where various factors may cause a degradation to the wireless communication (e.g., longer distances between devices in a sparse population area relative to a dense population area, obstacles, interference from other signals, etc.), which may be determined using a signal-to-noise ratio (SNR), a higher order MIMO system may improve the SNR and/or the data rate versus the range of the wireless communication. For example, the higher order MIMO system may implement beamforming, and/or receiver side equalizers that may improve the data rate versus range for the wireless communications.

In some embodiments of the present disclosure, a wireless device may be configured to change a mode of operation based on characteristics associated with the wireless network and/or with the devices included in the wireless network, where changing the mode of operation may improve performance of transmitted data using the wireless network based on an improved signal-to-noise ratio, increased throughput, and/or other metrics associated with data transmission. In some embodiments, the wireless device may automatically determine a mode of operation based on the characteristics and may direct a configuration of an adaptive module in view of the characteristics.

These and other implementations of the present disclosure will be explained with reference to the accompanying figures. It is to be understood that the figures are diagrammatic and schematic representations of such example implementations, and are not limiting, nor are they necessarily drawn to scale. In the figures, features with like numbers indicate like structure and function unless described otherwise.

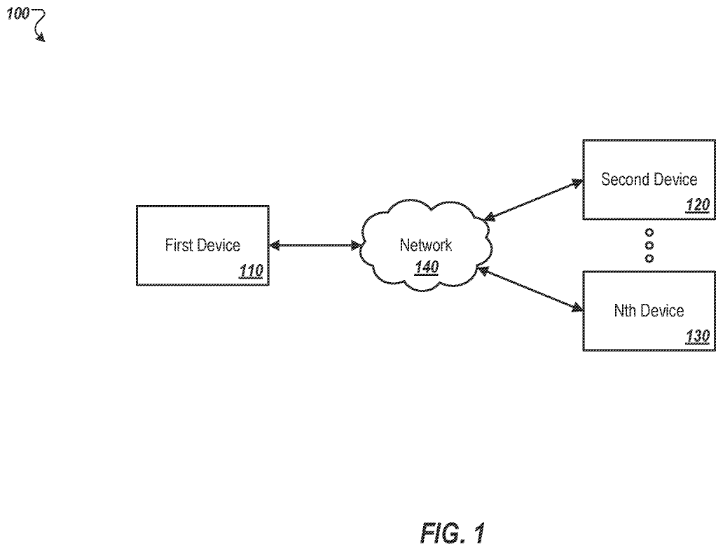

FIG. 1 illustrates an example environment 100 of wirelessly coupled devices and where one device may perform adaptive configurations, in accordance with at least one embodiment of the present disclosure. The environment 100 may include a first device 110, a second device 120, and nth device 130, and a network 140.

In some embodiments, the network 140 may be a wireless network configured to support wireless communication between devices coupled to the network 140, such as wireless communications between the first device 110 and the second device 120. In some embodiments, the network 140 may support IEEE 802.11 standard communications (e.g., Wi-Fi 7 (802.11be), Wi-Fi 6/6E (802.11 ax), etc.).

In some embodiments, the first device 110 may be a wireless network device that may be connected to one or more additional devices using the network 140. In some embodiments, the first device 110 may be configured to wirelessly communicate with the one or more additional devices coupled to the network 140, such as the second device 120 and/or the nth device 130. For example, the first device 110 may be an access point (AP) device in the environment 100 and may communicate with the second device 120 and/or the nth device 130 using the network 140. In some embodiments, the first device 110 may determine a mode of operation based on a first characteristic that may include one or more characteristics associated with the environment 100. For example, the first device 110 may determine the mode of operation in view of the first characteristic including at least a density of other devices connected to the network 140 (e.g., the second device and/or the nth device 130), a physical distance between the first device 110 and the other devices connected to the network 140, a determined interference to wireless signals in the network 140, a predicted interference to wireless signals in the network 140, and/or other characteristics associated with the environment 100.

Alternatively, or additionally, the first device 110 may determine the mode of operation based on a second characteristic that may include one or more device characteristics associated with the second device 120, the nth device 130, and/or the number of devices configured to communicate with the first device 110 using the network 140. For example, the first device 110 may determine the mode of operation in view of the second characteristic including at least a number of antennas associated with the second device 120 and/or the nth device 130, a number of supported spatial streams by the second device 120 and/or the nth device 130, an operational mode (e.g., single band/channel communications, dual band/channel communications, multi band/channel communications, etc.) associated with the second device and/or the nth device 130, various characteristics individually associated with the second device 120 and/or the nth device 130 in the environment 100 which may include, but not limited to, a SNR associated with communications with the first device 110 using the network 140, a received signal strength indicator (RSSI) associated with communications with the first device 110 using the network 140, and a modulation coding scheme (MCS) rate associated with communications with the first device 110 using the network 140.

In some embodiments, the first device 110 may be configured to determine the mode of operation automatically. For example, the first device 110 may determine the mode of operation in response to detecting a change in the number of devices in communication with the network 140, changes to devices (e.g., the second device 120 and/or the nth device 130) in communication with the first device 110 (e.g., number of antennas, number of supported spatial streams, physical distance from the first device, etc.), changes to the network 140 (e.g., observed amount of interference to signals in the network 140, predicted amount of interference to signals in the network 140, etc.), and/or other variations that may occur in the environment 100. In the present disclosure, a spatial stream may refer to a transmit and/or receive path by which data may be communicated between devices in the environment 100, such as a transmit/receive path between the first device 110 and the second device 120.

In these and other embodiments, the first device 110 may be configured to automatically determine the mode of operation of the first device 110 based on a first characteristic associated with the environment 100 and/or the second characteristic associated with the other devices (e.g., the second device 120 and/or the nth device 130) included in the environment 100, as described herein. Alternatively, or additionally, the first device 110 may configure an adaptive module within the first device 110 in accordance with the determined mode of operation. In some embodiments, the first device 110 may be configured to transmit data to the second device 120 and/or the nth device 130 using the adaptive module and in view of the determined mode of operation, as described herein.

As illustrated in FIG. 1, the second device 120 and the nth device 130 may be connected to the first device 110 via the network 140. In some embodiments, the nth device 130 may be representative of any number of additional devices that may be connected to the first device 110 via the network 140. In some embodiments, the nth device 130 may have the same or similar characteristics or components as the second device 120. For example, the nth device 130 may include the same number of antennas, may be capable of supporting the same number of spatial streams, may support single band/single channel communication and/or dual band/dual channel communications, etc., as the second device 120. Alternatively, or additionally, the nth device 130 (and/or any other additional devices that are not the second device 120 or the nth device 130) may differ from the second device 120. For example, the nth device 130 may differ from the second device 120 by having a different number of antennas, be capable of supporting a different number of spatial streams, may support a different communication configurations (e.g., the second device 120 may support single band/single channel communication and the nth device 130 may support dual band/dual channel communications), etc.

Modifications, additions, or omissions may be made to the environment 100 without departing from the scope of the present disclosure. For example, the designations of different elements in the manner described is meant to help explain concepts described herein and is not limiting. Further, the environment 100 may include any number of other elements or may be implemented within other systems or contexts than those described. For example, any of the components of FIG. 1 may be divided into additional or combined into fewer components.

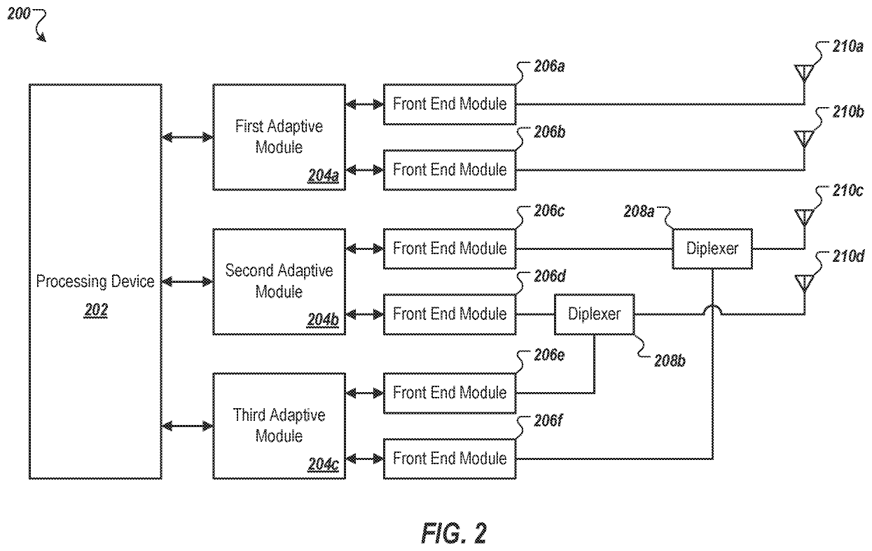

FIG. 2 illustrates an example wireless device 200 that supports adaptive configurations, in accordance with at least one embodiment of the present disclosure. In some embodiments, the wireless device 200 may be the same or similar as the first device 110 of FIG. 1. For example, the first device of FIG. 1 may be configured to automatically determine a mode of operation and/or configure at least one module therein to transmit data using the determined mode of operation, using at least the components as illustrated and described relative to the wireless device 200 of FIG. 2.

In some embodiments, the wireless device 200 may include a processing device 202, a first adaptive module 204a, a second adaptive module 204b, a third adaptive module 204c, referred to collectively as adaptive modules 204, a first front end module (FEM) 206a, a second FEM 206b, a third FEM 206c, a fourth FEM 206d, a fifth FEM 206e, a sixth FEM 206f, referred to collectively as FEMs 206, a first diplexer 208a, a second diplexer 208b, referred to collectively as diplexers 208, a first antenna 210a, a second antenna 210b, a third antenna 210c, and a fourth antenna 210d, referred to collectively as antennas 210.

In some embodiments, the processing device 202 may be communicatively coupled to the adaptive modules 204. In some embodiments, a high-speed interface may couple the processing device 202 to the adaptive modules 204. For example, the high-speed interface may be a peripheral component interconnect express (PCIe) standard, a universal serial bus (USB) standard, and/or any other high-speed interface. The processing device 202 may be configured to perform processing operations associated with at least automatically determining a mode of operation for the wireless device 200 and/or configuring the adaptive modules 204 for transmission of data in view of the determined more of operation. In some embodiments, the processing device 202 may perform the mode of operation determination and/or the adaptive modules 204 configuration. Alternatively, or additionally, the processing device 202 may direct the performance of the aforementioned.

In some embodiments, the processing device 202 may be configured to direct the transmission and reception of transmitted data via the antennas 210, including directing operations of components that may be configured to contribute to the transmission and/or reception of transmitted data. For example, the processing device 202 may direct operations associated with the adaptive modules 204, the FEMs 206, the antennas 210, and/or other components in the wireless device 200. In some embodiments, the processing device 202 may be configured to support high order MIMO operations (including single-user and/or multi-user), single band/channel communications, dual band/channel communications, multiple band/channel concurrent communications, multi-link operation (MLO), enhanced multi-link single radio (EMLSR), etc., any of which may be performed by the wireless device 200.

In some embodiments, the adaptive modules 204 may be configured to transition between a first mode of operation and a second mode of operation. In some embodiments, the adaptive modules 204 may perform a transition in response to an instruction obtained from the processing device 202. For example, in response to the processing device 202 determining a particular mode of operation, the adaptive modules 204 may be configured to perform operations using the particular mode of operation, which may include the adaptive modules 204 transitioning from a first mode of operation to the particular mode of operation.

In some embodiments, the adaptive modules 204 may support at least two modes of operation. A first mode of operation may include four antennas and four spatial streams. A second mode of operation may include one or more sets of antennas and one or more sets of spatial streams. In some embodiments, the first mode of operation may support single band/channel communications and the second mode of operation may support dual band/channel communications and/or multi band/channel communications. For example, the first mode of operation may include the four spatial streams selectively operating on one channel of a particular band (e.g., 2.4 GHz, 5 GHz, 6 GHz, etc.). In another example, the second mode of operation may include at least one spatial stream operating on a first channel of a first band and another spatial stream operating on a second channel of the first band. In these and other embodiments, the second mode of operation may support single band/channel communications, dual band/channel communications, and/or multi band/channel communications.

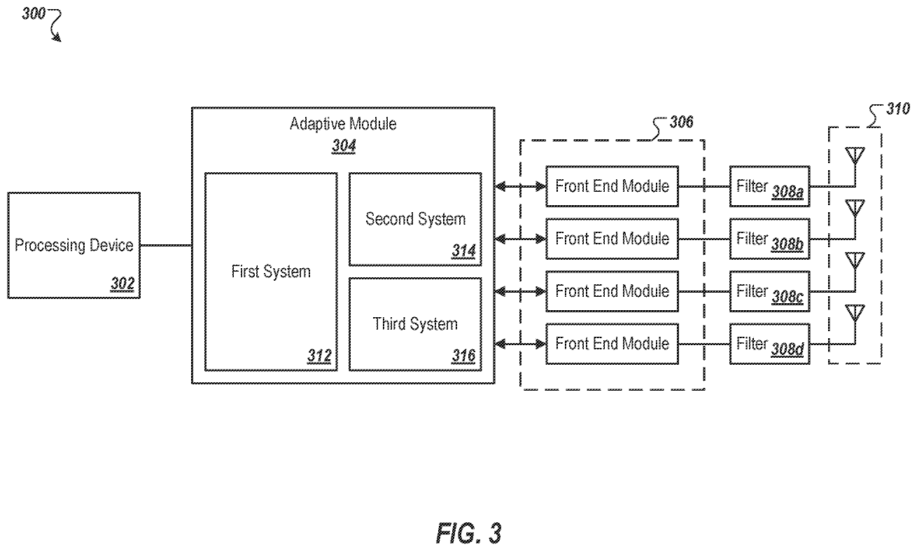

In general, the second mode of operation may include variations to the number of spatial streams, the bands that may be utilized, and/or the channels that may be utilized, where the bands and/or channels may be related or unrelated to the bands and/or channels utilized by the first mode of operation. For example, the second mode of operation may perform operations as having a first two antenna, two spatial stream system on a first channel (e.g., that may be the same channel used by the first mode of operation or a different channel used by the first mode of operation) of a first band (e.g., 6 GHz, 5 GHz, 2.4 GHz, etc.) and a second two antenna, two spatial stream system on a second channel of the 6 GHz band. In another example, the second mode of operation may perform operations as having a first two antenna, two spatial stream system on a first channel of a first band and a second two antenna, two spatial stream system on a second channel of the 5 GHz band. In another example, the second mode of operation may perform operations as having a first two antenna, two spatial stream system on a first channel of a first band and a second two antenna, two spatial stream system on a second channel of the 2.4 GHz band. Additional details associated with the adaptive modules may be further discussed relative to FIG. 3.

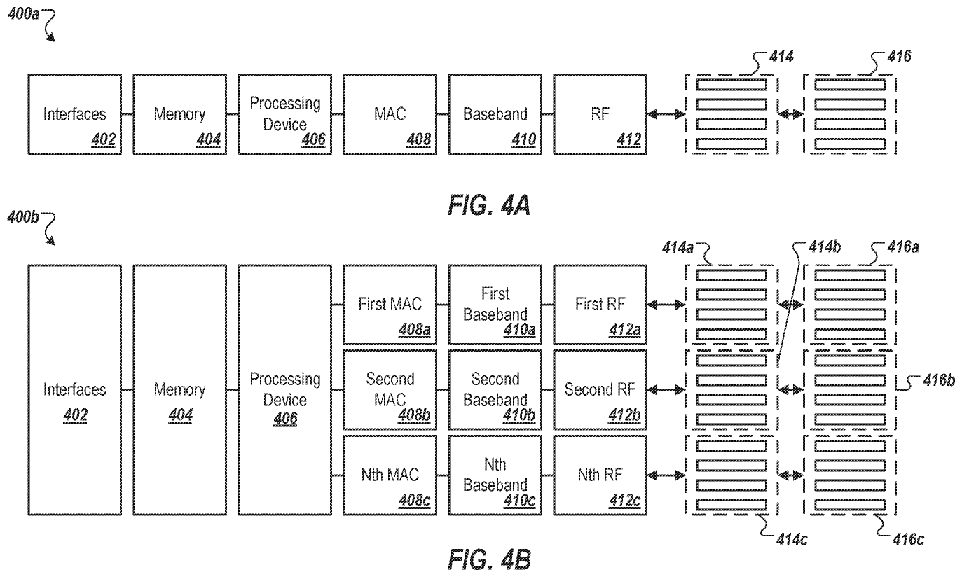

In some embodiments, the FEMs 206 may interface with the respective adaptive modules 204. In some embodiments, a single FEM of the FEMs 206 may interface with one adaptive module of the adaptive modules 204. For example, the first FEM 206a may interface with the first adaptive module 204a. Alternatively, or additionally, two or more FEMs of the FEMs 206 may interface with one of the adaptive modules 204. For example, the third FEM 206c and the fourth FEM 206d may interface with the second adaptive module 204b. In some embodiments, the number of FEMs that may interface with an adaptive module may vary based on the mode of operation associated with the adaptive module 204, as described herein, such as relative to FIGS. 4A-7B.

In some embodiments, the FEMs 206 may be configured to perform processing operations associated with transmitting and/or receiving signals by the wireless device 200. For example, the FEMs 206 may include one or more components and/or circuitry to process received signals prior to being obtained by the adaptive modules 204 and/or to process signals to be transmitted by the antennas 210 of the wireless device 200. In some embodiments, the FEMs 206 may be a single component to perform the signal processing, as described. For example, an integrated circuit may include one or more subcomponents that may individually contribute to processing a signal. Alternatively, or additionally, the FEMs 206 may be one or more individual circuits and/or components that may interface with one another to collectively perform the operations of the FEM. For example, the FEMs 206 may include filters, amplifiers, mixers, and/or other components that may be used in the processing of a signal.

In general, each of the FEMs 206 may correspond to an individual spatial stream associated with the wireless device 200. For example, the first FEM 206a may correspond to a first communication band/channel (e.g., UNII-5) using the first antenna 210a, the second FEM 206b may correspond to a second communication band/channel (e.g., UNII-6) using the second antenna 210b, and so forth. As described herein, one antenna may be associated with one or more FEMs, such as illustrated in FIG. 2 where the third FEM 206c and the sixth FEM 206f are associated with the third antenna 210c by way of the first diplexer 208a.

In some embodiments, the diplexers 208 may be used to perform multiplexing (e.g., frequency-domain multiplexing) between output signals from multiple FEMs 206 associated with two or more adaptive modules 204. For example, an output from the fourth FEM 206d may be multiplexed with an output from the fifth FEM 206e using the second diplexer 208b, such that the output from the fourth FEM 206d and the output from the fifth FEM 206e may be transmitted using the same antenna (e.g., as illustrated, the fourth antenna 210d). In some embodiments, the diplexers 208 may be used to multiplex signals that may have different frequencies, but that may be transmitted using the same antenna.

In some embodiments, the antennas 210 may be used to transmit and/or receive wireless signals in a network, such as the network 140 of FIG. 1. In some embodiments, the antennas 210 may be configured to support signals of a particular frequency or frequency range. For example, the first antenna 210a and the second antenna 210b may be configured to support a 6 GHz frequency band and the third antenna 210c and the fourth antenna 210d may be configured to support a 2.4 GHz and/or 5 GHz frequency band. In instances in which the antennas 210 are configured to support more than one frequency band (e.g., 2.4 GHz and 5 GHz), the diplexers 208 may be used to multiplex signals from the particular frequency bands, such that the antennas 210 may support the frequency bands.

In some embodiments, the antennas 210 associated with the adaptive modules 204 illustrated in FIG. 2 may differ than the number illustrated. For example, each of the adaptive modules 204 may be coupled (either directly, such as the first adaptive module 204a to the first antenna 210a, or indirectly through a diplexer, such as the third adaptive module 204c to the third antenna 210c via the first diplexer 208a) to four antennas via four FEMs. In such an arrangement, each of the adaptive modules 204 of the wireless device 200 may be configured to support the first mode of operation (e.g., four antennas and/or four spatial streams) and/or the second mode of operation and the iterations thereof. For example, the first adaptive module 204a may be coupled to a first set of four antennas via a first set of four FEMs, the second adaptive module 204b may be coupled to a second set of four antennas via a second set of four FEMs, and/or the third adaptive module 204c may be coupled to a third set of four antennas via a third set of four FEMs. Alternatively, or additionally, the third adaptive module 204c may be coupled to the second set of four antennas (e.g., the set of four antennas the second adaptive module 204b may be coupled to) via a third set of four FEMs. An example of the number of antennas and FEMs coupled to an individual adaptive module may be further illustrated in FIG. 3.

In instances in which each of the adaptive modules 204 are connected to four antennas, and where each of the adaptive modules 204 are configured for the second mode of operation having two sets of two antennas and two spatial streams (e.g., a first 2×2:2ss system and a second 2×2:2ss system, where 2×2 indicates two antennas and 2ss indicates two spatial streams), two spatial streams associated with the first adaptive module 204a may be grouped into a first channel (e.g., channel 1.1 on the 6 GHz band) and two spatial streams associated with the first adaptive module 204a may be grouped into a second channel (e.g., channel 1.2 on the 6 GHz band). In some embodiments, the first channel and the second channel may support non-simultaneous transmit receive (STR) multi-link operation (MLO) communications and/or dual channel communications.

Alternatively, or additionally, two spatial streams associated with the second adaptive module 204b may be grouped into a third channel (e.g., channel 2.1 on the 5 GHz band) and two spatial streams associated with the second adaptive module 204b may be grouped into a fourth channel (e.g., channel 2.2 on the 5 GHz band). In some embodiments, the third channel and the fourth channel may support non-STR MLO communications and/or dual channel communications.

Alternatively, or additionally, two spatial streams associated with the third adaptive module 204c may be grouped into a fifth channel (e.g., channel 3.1 on the 2.4 GHz band) and two spatial streams associated with the third adaptive module 204c may be grouped into a sixth channel (e.g., channel 3.2 on the 2.4 GHz band). In some embodiments, the fifth channel and the sixth channel may support non-STR MLO communications and/or dual channel communications.

In these and other embodiments, the combination of the first channel, the second channel, the third channel, the fourth channel, the fifth channel, and/or the sixth channel may operate together to support STR communications and/or MLO communications. In some embodiments, MLO may include aggregating two or more channels that may be included in different bands and STR may include perform transmission and receive operations at the same time, where transmissions may occur on a first spatial stream and the receptions may occur on a second spatial stream.

Modifications, additions, or omissions may be made to the wireless device 200 without departing from the scope of the present disclosure. For example, the designations of different elements in the manner described is meant to help explain concepts described herein and is not limiting. Further, the wireless device 200 may include any number of other elements or may be implemented within other systems or contexts than those described. For example, any of the components of FIG. 2 may be divided into additional or combined into fewer components. Non-STR may include performing transmissions across multiple spatial streams during a first time and performing receptions across the multiple spatial streams during a second time.

FIG. 3 illustrates an example wireless device 300 that supports adaptive configurations, in accordance with at least one embodiment of the present disclosure. The wireless device 300 of FIG. 3 may be the same or similar as at least a portion of the wireless device 200 of FIG. 2 and may illustrate one or more additional details associated with the wireless device 200 of FIG. 2.

In some embodiments, the wireless device 300 may include a processing device 302, an adaptive module 304, FEMs 306, a first filter 308a, a second filter 308b, a third filter 308c, a fourth filter 308d, referred to collectively as filters 308, and antennas 310. In some embodiments, the adaptive filter 304 may be configured to operate in various modes of operation, which may be illustrated by a first system 312, a second system 314, and a third system 316. The processing device 302, the adaptive module 304, the FEMs 306, and the antennas 310 may be the same or similar as the processing device 202, the adaptive modules 204, the FEMs 206, and the antennas 210 of FIG. 2, respectively. In some embodiments, the wireless device 300 illustrates different configurations of the adaptive module 304 and the connections between, the number of the antennas 310 that may be associated with the adaptive module 304 (as described, but not illustrated, relative to FIG. 2), and/or the filters 308 that may be included in the wireless device 300.

In some embodiments, the first system 312 may be associated with the first mode of operation, where the adaptive module 304 may be configured to use the four antennas 310 and four spatial streams where the four spatial streams be operated on the same band and/or same channel as one another. For example, the first mode of operation may include high order MIMO operations.

In some embodiments, the second system 314 and/or the third system 316 may be associated with the second mode of operation, where the second system 314 of the adaptive module 304 may be configured to use a first set of the antennas 310 and a first set of the spatial streams and the third system 316 may be configured to use a second set of the antennas 310 and a second set of the spatial streams. In such instances, the first set may correspond to a first band and/or a first channel and the second set may correspond to a second band and/or a second channel, where the first band may be the same or may differ from the second band and the first channel may be the same or may differ from the second channel. For example, the first set may be in the 6 GHz band and a first channel therein and the second set may be in the 6 GHz band and a second channel therein.

In some embodiments, the second system 314 and the third system 316 may each be configured to support two of the antennas 310 and two corresponding spatial streams (e.g., both the second system 314 and the third system 316 may be 2×2:2ss), such that the second mode of operation may support dual band/channel communications. Alternatively, or additionally, the number of the antennas 310 and/or the corresponding spatial streams may be asymmetrical distributed between the second system 314 and the third system 316. For example, the second system may be configured to support three of the antennas 310 and three corresponding spatial streams and the third system 316 may be configured to support one of the antennas 310 and one correspond spatial stream, such that the wireless device 300 may support the second mode of operation. In these and other embodiments, the second mode of operation may support MLO communications using the spatial streams associated with the second system 314 and the third system 316.

In these and other embodiments, the number of spatial streams included in the second mode of operation may be the same as the number of spatial streams included in the first mode of operation. For example, in instances in which the first mode of operation includes four spatial streams, the combination of the spatial streams in the second mode of operation may be equal to four. As an example, the second mode of operation may include four individual systems each configured to support one spatial stream, such that the second mode may include a sum of four spatial streams that may be equal to the four spatial streams supported by the first mode of operation. In general, in instances in which the number of spatial streams supported in the first mode of operation is X and the number of spatial streams supported in the second mode of operation is X₁, X₂, . . . , Xn, then the sum of X₁, X₂, . . . , Xn (e.g., X₁+X₂+ . . . +Xn) may be equal to X

In some embodiments, the output from the FEMs 306 may be input to the filters 308. In some embodiments, the filters 308 may be applied to the individual signals in the various spatial streams, which may support multi band/channel communications. For example, a first signal filtered by the first filter 308a may be separated from a second signal filtered by the second filter 308b such that interference between the first signal and the second signal may be reduced or eliminated and the first signal and the second signal may be used in multi band/channel communications. As such, the first signal and the second signal may be used concurrently and/or simultaneously as one another. In some embodiments, each of the filters 308 may be the same as one another. Alternatively, or additionally, each of the filters 308 may differ from one another.

In instances in which the wireless device includes more than one adaptive module (e.g., the adaptive modules 204 in the wireless device 200 of FIG. 2), the filters 308 may differ relative to the different adaptive modules. For example, first filters associated with a first adaptive module may be configured to filter 6 GHz band signals (or unlicensed national information infrastructure (U-NII)-5 through U-NII-8), second filters associated with a second adaptive module may be configured to filter 5 GHz band signals (or U-NII-1 through U-NII-4), and so forth. In such instances, the filters that may be associated with a particular band may be further differentiated relative to a particular channel within the band. For example, a first filter associated with a first adaptive module may be configured to filter signals in the U-NII-5 channel (e.g., 6 GHz band), a second filter associated with the first adaptive module may be configured to filter signals in the U-NII-5 and the U-NII-6 band, and so forth.

In these and other embodiments, a channel avoidance algorithm or an enhanced multi-link single radio (EMLSR) mode of operation may be implemented to reduce or mitigation interference that may occur between various spatial streams in the wireless device 300 during concurrent and/or simultaneous operations. In some embodiments, the channel avoidance and/or EMLSR mode of operation may be used in lieu of the filters 308 or in conjunction with the filter 308.

Modifications, additions, or omissions may be made to the wireless device 300 without departing from the scope of the present disclosure. For example, the designations of different elements in the manner described is meant to help explain concepts described herein and is not limiting. Further, the wireless device 300 may include any number of other elements or may be implemented within other systems or contexts than those described. For example, the adaptive module 304 may include more or less systems than illustrated (e.g., the first system 312, the second system 314, and the third system 316), which may correspond to the modes of operation of the adaptive module 304. For example, in instances in which the second mode of operation includes four individual antennas and four corresponding individual spatial streams (e.g., 1×1:1ss), the adaptive module 304 may include the first system 312 that may correspond to the first mode of operation, and the second system 314, the third system 316, and at least two additional systems (not illustrated) that may correspond to the second mode of operation, where the second system 314, the third system 316, and each of the two additional systems individual correspond to one antenna and a corresponding spatial stream (e.g., each of the systems in the second mode of operation are 1×1:1ss systems).

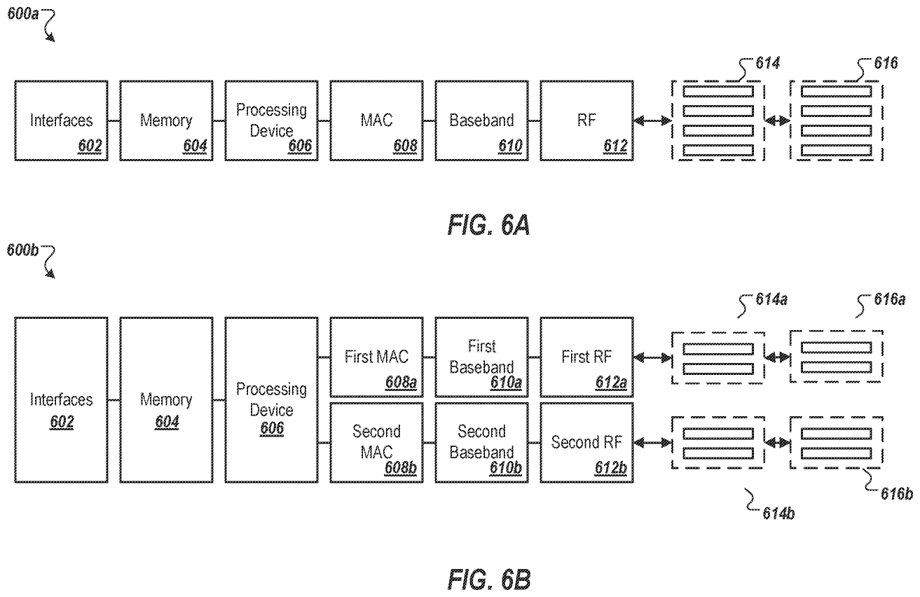

FIGS. 4A-7B illustrate example arrangements of wireless devices that support adaptive configurations, in accordance with at least one embodiment of the present disclosure. In general, some of the components included in the wireless devices illustrated in FIGS. 4A-7B may be the same or similar as one another and/or may be similarly numbered. For example, interfaces 402 of FIG. 4 may be the same or similar as interfaces 602 of FIG. 6, and so forth. In these and other embodiments, similarly named and numbered components in the figures (e.g., interfaces *02 (indicating 402, 502, 602, and 702, corresponding to the figure number), memory *04, processing device *06, and so forth) may be the same or similar as one another, unless explicitly stated otherwise. Alternatively, or additionally, some components included in the FIGS. 4A-7B may be the same or similar as components described in FIGS. 2 and 3. For example, the processing devices *06 (e.g., 406, 506, etc.) may be the same or similar as the processing device 202 of FIG. 2 and/or the processing device 302 of FIG. 3 and may be configured to perform substantially the same operations as described. Other examples may include the FEMs *14 and the filters *16 that may be the same or similar as the FEMs 206/306 and the filters 308 of FIG. 3, respectively.

FIGS. 4A and 4B illustrate example arrangements of wireless devices 400a and 400b, respectively, that support adaptive configurations, in accordance with at least one embodiment of the present disclosure. The wireless devices 400a and 400b may include interfaces 402, a memory 404, a processing device 406, a medium access control (MAC) 408 (which may include a first MAC 408a, a second MAC 408b, and an nth MAC 408c, referred to collectively as MAC 408, as illustrated in FIG. 4B), a baseband component 410 (which may include a first baseband component 410a, a second baseband component 410b, and an nth baseband component 410c, referred to collectively as baseband component 410, as illustrated in FIG. 4B), a radio frequency (RF) component 412 (which may include a first RF component 412a, a second RF component 412b, and an nth RF component 412c, referred to collectively as RF component 412, as illustrated in FIG. 4B), a FEM 414 (which may include a first FEM 414a, a second FEM 414b, and an nth FEM 414c, referred to collectively as FEM 414, as illustrated in FIG. 4B), and a filter 416 (which may include a first filter 416a, a second filter 416b, and an nth filter 416c, referred to collectively as filter 416, as illustrated in FIG. 4B). The wireless device 400a and the wireless device 400b may be referred to jointly (e.g., as they may include the same or similar components in different arrangements) as the wireless device 400.

In some embodiments, the wireless devices 400a and 400b may be a network device, such as an access point, that may be configured to communicate with one or more other devices using a wireless network. In some embodiments, some components of the wireless devices 400a and 400b (e.g., the interfaces 402, the memory 404, and the processing device 406) may be configured to support at least the first mode of operation and the second mode of operation, as described herein. Alternatively, or additionally, the components of the wireless devices 400a and 400b may be configured to support high order MIMO communications, where associated spatial streams may operate using the same band/channel as one another, such as the first mode of operation described herein.

Alternatively, or additionally, some components of the wireless devices 400a and 400b (e.g., the MAC 408, the baseband component 410, and the RF 412) may be configured to support communications using one or more bands/channels where various numbers of spatial streams may be allocated to the one or more bands/channels, such as the second mode of operation described herein. For example, as illustrated in FIG. 4A, the wireless device 400a may support multiple spatial streams that may operate using one band/channel (e.g., using the MAC 408, the baseband component 410, and the RF component 412). In another example, as illustrated in FIG. 4B, the wireless device 400b may support multiple spatial streams that may operate using one or more bands/channels (e.g., the first MAC 408a, the first baseband component 410a, the first RF component 412a, the first FEM 414a, and the first filter 416a using a first band/channel, the second MAC 408b, the second baseband component 410b, the second RF component 412b, the second FEM 414b, and the second filter 416b using a second band/channel, and so forth).

In some embodiments, the RF component 412 may be a circuit that may be configurable between the first mode of operation and the second mode of operation. In some embodiments, the RF component 412 may include one or more voltage controlled oscillators (VCOs) that may support various frequencies (e.g., frequencies that may be associated with one or more bands/channels). For example, the VCOs may be configured to support communications associated with any channel included in any of the wireless bands (e.g., 2.4 GHz, 5 GHz, and 6 GHz).

In some embodiments, FIG. 4A illustrates the wireless device 400a configured to support the first mode of operation. In such a configuration, the wireless device 400a may support one or more spatial streams that may be located on the same band/channel as one another. As such, the wireless device 400a may support high order MIMO operations (e.g., having a configuration such as 4×4:4ss). In some embodiments, the first mode of operation may include one or more additional features (e.g., in addition to the high order MIMO operations as described) which may contribute to an increased range of operation and/or improved throughput. For example, single user/multi-user MIMO, beamforming, receive-side equalization, spatial stream diversity, and/or spatial stream multiplexing may be implemented in concert with the first mode of operation, which may improve the range of operation (e.g., a range between the wireless device 400 and a receiving/linked device) and/or the throughput between the wireless device 400 and the receiving/linked device.

In some embodiments, FIG. 4B illustrates the wireless device 400b configured to support the second mode of operation. In such a configuration, the wireless device 400b may support one or more groups of MIMO spatial streams on one or more bands/channels as one another. As such, the wireless device 400b may support MLO across the multiple spatial streams included in the wireless device 400b. For example, the first MAC 408a, the first baseband component 410a, the first RF component 412a, the first FEM 414a, and the first filters 416a may support one or more first spatial streams (and/or may be connected to one or more first antennas) associated with a first band/channel, the second MAC 408b, the second baseband component 410b, the second RF component 412b, the second FEM 414b, and the second filters 416b may support one or more second spatial streams (and/or may be connected to one or more second antennas), and so forth. In the example, the first spatial streams and the second spatial streams may contribute to the support of MLO by the wireless device 400b.

In some embodiments, the wireless device 400a and the wireless device 400b may be variations of the wireless device 400, having two different configurations based on a determined mode of operation. For example, a combination of the MAC 408, the baseband component 410, and the RF component 412 may be the same or similar as the adaptive modules 204 of FIG. 2 and/or the adaptive module 304 of FIG. 3. As such, in the first mode of operation, the wireless device 400 may be arranged as illustrated by the wireless device 400a, and in the second mode of operation, the wireless device 400 may be arranged as illustrated by the wireless device 400b (e.g., having multiple MACs, baseband components, and RF components to individually support one or more spatial streams).

In some embodiments, the wireless device 400 may be configured to switch from the configuration of the wireless device 400a to the configuration of the wireless device 400b, and the reverse. In some embodiments, the RF component 412 may be configured to operation in a single band/channel or in multiple bands/channels, in accordance with the modes of operations described herein. As described, the RF component 412 may include one or more VCOs and the VCOs may be configured for fast stabilization of frequency as part of band/channel switching associated with a change to the mode of operation of the wireless device 400.

As described herein, the determination and/or switching between the modes of operation may be based on one or more characteristics associated with the network and/or with a device linked to the wireless device 400 (such as via the network). For example, the wireless device 400 may be configured to switch between the first mode of operation and the second mode of operation on a per physical layer protocol data unit (PPDU) basis. In some embodiments, the configuration of the VCOs from fast stabilization of frequency may contribute to the switching between the first mode of operation and the second mode of operation (and the associated band/channel switching) on a per PPDU basis. As described, the wireless device 400 may be configured to switch between the first mode of operation and the second mode of operation automatically and/or dynamically, such as in response to determined (e.g., observed, predicted, and/or calculated) characteristics.

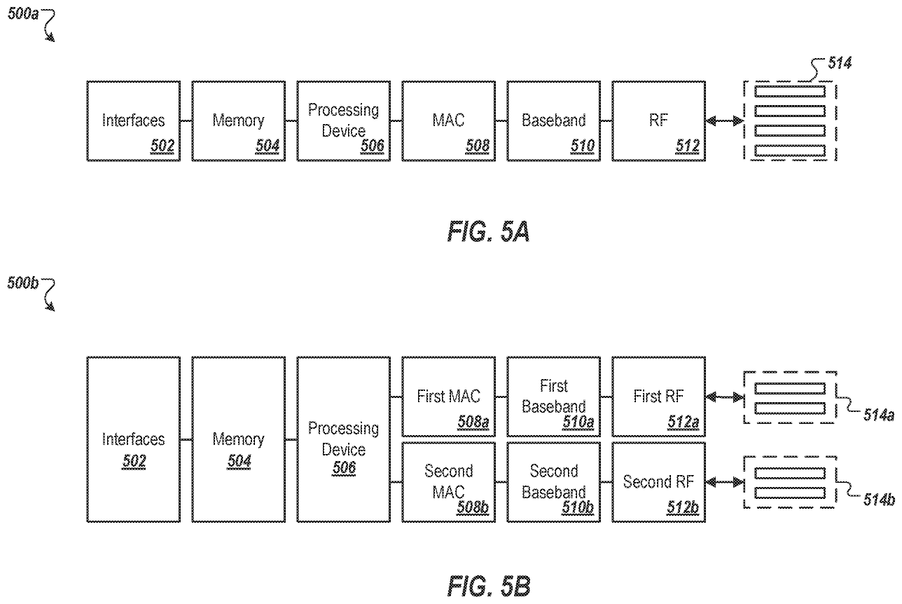

FIGS. 5A and 5B illustrate example arrangements of wireless devices 500a and 500b, respectively, that support adaptive configurations, in accordance with at least one embodiment of the present disclosure. The wireless devices 500a and 500b may include interfaces 502, a memory 504, a processing device 506, a medium access control (MAC) 508 (which may include a first MAC 508a and a second MAC 508b, referred to collectively as MAC 508, as illustrated in FIG. 5B), a baseband component 510 (which may include a first baseband component 510a and a second baseband component 510b, referred to collectively as baseband component 510, as illustrated in FIG. 5B), a radio frequency (RF) component 512 (which may include a first RF component 512a and a second RF component 512b, referred to collectively as RF component 512, as illustrated in FIG. 5B), and a FEM 514 (which may include a first FEM 514a and a second FEM 514b, referred to collectively as FEM 514, as illustrated in FIG. 5B). The wireless device 500a and the wireless device 500b may be referred to jointly (e.g., as they may include the same or similar components in different arrangements) as the wireless device 500.

In some embodiments, the interfaces 502, the memory 504, the processing device 506, the MAC 508, the baseband component 510, the RF component 512, and the FEM 514 may be the same or similar as the interfaces 402, the memory 404, the processing device 406, the MAC 408, the baseband component 410, the RF component 412, and the FEM 414 of FIGS. 4A and 4B, respectively. In instances in which some or all of the components illustrated in FIGS. 5A and 5B are the same or similar as the components illustrated in FIGS. 4A and 4B, the components may be configured to perform the same or similar operations, unless described otherwise.

In some embodiments, the wireless device 500a may be associated with the first mode of operation, as described herein. As illustrated, the wireless device 500a may perform operations using the MAC 508, the baseband component 510, the RF component 512, four antennas (not illustrated, but may be coupled to the FEM 514), and four spatial streams (e.g., 4×4:4ss), where the four spatial streams may be operated selectively on a particular channel of a particular band (e.g., 2.4 GHz, 5 GHz, 6 GHz, etc.).

In some embodiments, the wireless device 500b may be associated with the second mode of operation, as described herein. As illustrated, the wireless device 500b may perform operations using two sets of components: the first MAC 508a, the first baseband component 510a, the first RF component 512a, two antennas (not illustrated), and two spatial streams, and the second MAC 508b, the second baseband component 510b, the second RF component 512b, two antennas (not illustrated), and two spatial streams (e.g., two 2×2:2ss). In such an arrangement, the wireless device 500b may support dual band/channel concurrent communications using two sets of spatial streams that may be on two particular channels on one or more particular bands.

For example, the second mode of operation may include a two antenna, two spatial stream (e.g., 2×2:2ss) dual band/channel concurrent mode of operation that may operate two spatial streams on two channels of a given band. For example, the second mode of operation may include a first two antenna, two spatial stream system on a first channel of the 6 GHz band (which may be the same channel as the first mode of operation) and a second two antenna, two spatial stream system on a second channel of the 6 GHz band. In another example, the second mode of operation may include a two antenna, two spatial stream system on the same channel as the first mode of operation and a second two antenna, two spatial stream system on a particular channel of the 5 GHz band. In another example, the second mode of operation may include a two antenna, two spatial stream system on the same channel as the first mode of operation and a second two antenna, two spatial stream system on a particular channel of the 2.4 GHz band.

In some embodiments, the configuration of the wireless device 500a and the configuration of the wireless device 500b illustrate the number of spatial streams in the first mode of operation (e.g., the wireless device 500a) may be equal to the sum of the spatial streams in the second mode of operation (e.g., the wireless device 500b). For example, the FEM 514 is arranged to support four spatial streams (e.g., the individual boxes in the FEM 514 represent individual FEMs, each configured to support a spatial stream), and the first FEM 514a and the second FEM 514b are each configured to support two spatial streams, such that the wireless device 500b may be arranged to support four spatial streams.

FIGS. 6A and 6B illustrate example arrangements of wireless devices 600a and 600b, respectively, that support adaptive configurations, in accordance with at least one embodiment of the present disclosure. The wireless devices 600a and 600b may include interfaces 602, a memory 604, a processing device 606, a medium access control (MAC) 608 (which may include a first MAC 608a and a second MAC 608b, referred to collectively as MAC 608, as illustrated in FIG. 6B), a baseband component 610 (which may include a first baseband component 610a and a second baseband component 610b, referred to collectively as baseband component 610, as illustrated in FIG. 6B), a radio frequency (RF) component 612 (which may include a first RF component 612a and a second RF component 612b, referred to collectively as RF component 612, as illustrated in FIG. 6B), a FEM 614 (which may include a first FEM 614a and a second FEM 614b, referred to collectively as FEM 614, as illustrated in FIG. 6B), and a filter 616 (which may include a first filter 616a and a second filter 616b, referred to collectively as filter 616, as illustrated in FIG. 6B). The wireless device 600a and the wireless device 600b may be referred to jointly (e.g., as they may include the same or similar components in different arrangements) as the wireless device 600.

In some embodiments, the interfaces 602, the memory 604, the processing device 606, the MAC 608, the baseband component 610, the RF component 612, and the FEM 614 may be the same or similar as the interfaces 402, the memory 404, the processing device 406, the MAC 408, the baseband component 410, the RF component 412, and the FEM 414 of FIGS. 4A and 4B, respectively. In instances in which some or all of the components illustrated in FIGS. 6A and 6B are the same or similar as the components illustrated in FIGS. 4A and 4B, the components may be configured to perform the same or similar operations, unless described otherwise.

In some embodiments, the wireless device 600 may be similar to the wireless device 500 and may include one or more filters (the filters 616) that may be individually associated with the spatial streams supported by the wireless device 600. In some embodiments, the filters 616 may be coupled to the FEMs 614 and may be configured to perform a filtering operation to the spatial stream output from the FEMs 614 (during a transmitting operation).

In some embodiments, a number of the filters 616 may be the same in the first mode of operation (e.g., the wireless device 600a) as the second mode of operation (e.g., the wireless device 600b). For example, as illustrated, the wireless device 600a includes four filters illustrated by the blocks within the filter 616 (where each filter may be individually associated with a spatial stream) and the wireless device 600b includes a first set of two filters (e.g., the first filter 616a) and a second set of two filters (e.g., the second filter 616b). Alternatively, or additionally, a filter type associated with the filters 616 may be similar or the same in the first mode of operation as the second mode of operation. For example, in instances in which the wireless device 600 transitions from the first mode of operation to the second mode of operation, and vice versa, the filters 616 may remain unchanged although the filters 616 may be grouped into different sets and/or associated with different spatial streams.

In some embodiments, the filters 616 may be uniform among one another. For example, each of the filters 616 may be a band pass filter configured to filter on a particular frequency or frequency range. Alternatively, or additionally, one or more particular filters of the filters 616 may differ from the other filters based on the band/channel the one or more particular filters may be configured to filter. For example, a first spatial stream (in either the first mode of operation or the second mode of operation) may be in the 6 GHz band and may include a first filter associated with 6 GHz frequencies and a second spatial stream may be in the 5 GHz band and may include a second filter associated with 5 GHz frequencies.

In instances in which the wireless device 600 performs operations using the second mode of operation (e.g., dual band/channel concurrent communications), the wireless device 600 may implement EMLSR to reduce or mitigate interference between the first spatial streams on a first band/channel and the second spatial streams on a second band/channel. For example, in instances in which the first set of spatial streams (e.g., 2×2:2ss) may be operating using a first band/channel and the second set of spatial streams (e.g., 2×2:2ss) may be operation using a second band/channel, the implementation of EMLSR by the wireless device 600 may reduce and/or mitigate interference between the first band/channel and the second band/channel.

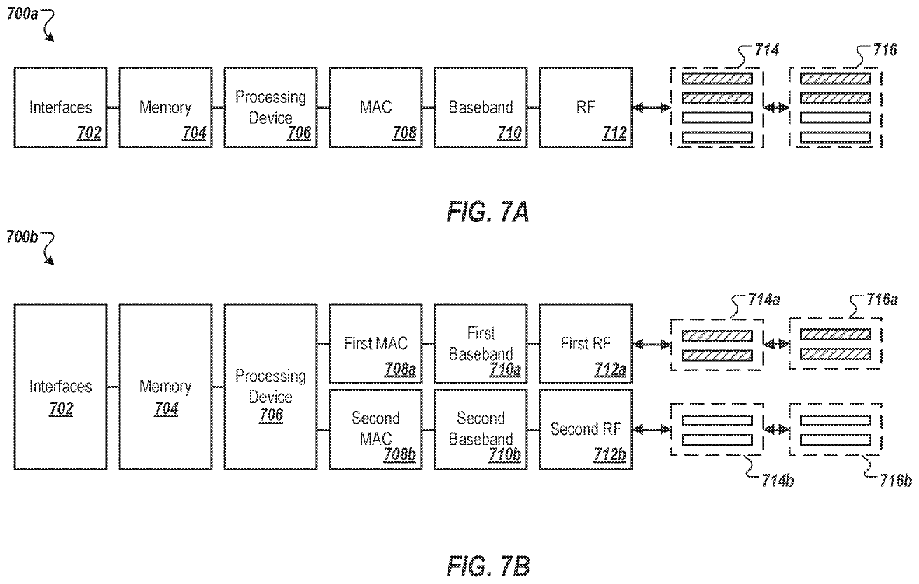

FIGS. 7A and 7B illustrate example arrangements of wireless devices 700a and 700b, respectively, that support adaptive configurations, in accordance with at least one embodiment of the present disclosure. The wireless devices 700a and 700b may include interfaces 702, a memory 704, a processing device 706, a medium access control (MAC) 708 (which may include a first MAC 708a and a second MAC 708b, referred to collectively as MAC 708, as illustrated in FIG. 7B), a baseband component 710 (which may include a first baseband component 710a and a second baseband component 710b, referred to collectively as baseband component 710, as illustrated in FIG. 7B), a radio frequency (RF) component 712 (which may include a first RF component 712a and a second RF component 712b, referred to collectively as RF component 712, as illustrated in FIG. 7B), a FEM 714 (which may include a first FEM 714a and a second FEM 714b, referred to collectively as FEM 714, as illustrated in FIG. 7B), and a filter 716 (which may include a first filter 716a and a second filter 716b, referred to collectively as filter 716, as illustrated in FIG. 7B). The wireless device 700a and the wireless device 700b may be referred to jointly (e.g., as they may include the same or similar components in different arrangements) as the wireless device 700.

In some embodiments, the interfaces 702, the memory 704, the processing device 706, the MAC 708, the baseband component 710, the RF component 712, the FEM 714, and the filters 716 may be the same or similar as the interfaces 602, the memory 604, the processing device 606, the MAC 608, the baseband component 610, the RF component 612, the FEM 614, and the filters 616 of FIGS. 6A and 6B, respectively. In instances in which some or all of the components illustrated in FIGS. 7A and 7B are the same or similar as the components illustrated in FIGS. 6A and 6B, the components may be configured to perform the same or similar operations, unless described otherwise.

As described relative to FIGS. 6A and 6B, FIGS. 7A and 7B illustrate the wireless device 700 that may include different filters that may be applied to different spatial streams in the wireless device 700. For example, as illustrated, the first filter 716a (illustrated as having diagonal fill lines) may differ from the second filter 716b (illustrated as having no fill lines) in frequencies that may be filtered by the filters 716. In some embodiments, the first filter 716a and the second filter 716b may include some frequency overlap, such that the first filter 716a and the second filter 716b may be configured to filter a single frequency, such that may be used in the first mode of operation for high order MIMO communications. For example, the first filter 716a may be configured to filter signals having frequencies in the U-NII-5 through U-NII-8 bands and the second filter 716b may be configured to filter signals having frequencies in the U-NII-5 through U-NII-6 bands. As such, the wireless device 700 may be configured to perform communications using the first mode of operation (e.g., 4×4:4ss) using U-NII-5/6 and the wireless device 700 may be configured to perform communications using the second mode of operation (e.g., two 2×2:2ss) using U-NII-5/6 for a first set of spatial streams and U-NII-7/8 for a second set of spatial streams.

In some embodiments, the first mode of operation may be used in instances in which a linked device (e.g., a second device linked to the wireless device 700, as described herein) is a long physical distance from the wireless device 700, where beamforming of the signal may be utilized to improve the transmission range of the transmitted signal. In instances in which the linked device supports four spatial streams and/or three spatial streams (e.g., 3×3:3ss), the first mode of operation may increase throughput of the communication and/or decrease latency in the communication. In some embodiments, the second mode of operation including at least two sets of spatial streams operating in different bands/channels, may be used when the linked device support dual band/channel concurrent communications.

In these and other embodiments, various configurations of filters may be used to accomplish the above-described operations associated with the filters relative to the first mode of operation and the second mode of operation. For example, in instances in which the 6 GHz band is utilized, a first set of spatial streams may use band pass filters permitting U-NII-7 and U-NII-8 and a second set of spatial streams may use band pass filters permitting U-NII-5 through U-NII-8. In another example, in instances in which the 5 GHz band is utilized, a first set of spatial streams may use band pass filters permitting U-NII-1 and U-NII-2 and a second set of spatial streams may use band pass filters permitting U-NII-1, U-NII-2a, U-NII-2c, U-NII-3, and/or U-NII-4.

In some embodiments, the wireless device 700 may be configured to communicate with one or more linked devices, which may be based on the mode of operation of the wireless device 700 and/or the capabilities of the linked devices. For example, in instances in which the linked device supports up to four spatial streams, the wireless device 700 may communicate with the linked device using the first mode of operation or the second mode of operation.

In instances in which multiple linked devices are wirelessly coupled with the wireless device 700 and the multiple linked devices are individually configured as single spatial stream (e.g., 1×1:1ss) devices, the wireless device 700 may operate in the first mode of operation and perform MU-MIMO communications, such that the wireless device 700 may communicate with each of the multiple devices concurrently. In such instances, as the physical distance between the wireless device 700 and the multiple linked devices increases, the wireless device 700 may use beamforming as part of the first mode of operation which may contribute to increased signal gains (e.g., up to 3 dB relative to the second mode of operation) between the wireless device 700 and the multiple linked devices. Alternatively, or additionally, equalizer devices, equalization methods, and/or spatial diversity (as described herein) may be implemented within the multiple linked devices, which may contribute to gains in the received signal from the wireless device 700.

In some embodiments, the wireless device 700 may be configured to communicate with at least two linked devices where the two linked devices may individually be configured to support at least two spatial streams while a first linked device may be configured for single band/channel communications and a second linked device may be configured to dual band/channel communications. The wireless device 700 may be configured to communicate with the first linked device in the second mode of operation using two spatial streams, which may provide an increased speed relative to communications using a single stream, and the second mode of communication may provide support for a single stream of communication as well.

The wireless device 700 may be configured to communicate with the second linked device using two spatial streams and dual band/channel communications. As such, the wireless device 700 may utilize MLO, such as by using the second mode of operation, to transmit more data concurrently, which may increase the speed of data communication between the wireless device 700 and the second linked device. Alternatively, or additionally, the wireless device 700 may utilize STR and/or non-STR communications (e.g., in conjunction with MLO) based on the capabilities of the second linked device. In these and other embodiments, utilizing MLO between the wireless device 700 and the second linked device may enhance the reliability of the connection between the wireless device 700 and the second linked device in addition to the potentially increase rates of communication.

In some embodiments, the second linked device may be arranged having components that may be the same or similar as the wireless device 700. For example, the second linked device may include interfaces, memory, a processing device, multiple MACs, multiple baseband components, multiple RF components, multiple FEMs, and/or multiple filters, similar to the wireless device 700b of FIG. 7B. In some embodiments, the filters associated with the second linked device may be the same or similar as the filter 716 associated with the wireless device 700. For example, both the wireless device 700 and the second linked device may include one or more U-NII-5 through U-NII-8 filters and one or more U-NII-5 through U-NII-6 band pass filters.

In some embodiments, the wireless device 700 may select a mode of operation (and/or associated operations) based on capabilities of the second linked device. For example, in instances in which the second linked device supports dual band/channel communications, the wireless device 700 may select the second mode of operation, and/or may select MLO in addition to the second mode of operation. Alternatively, or additionally, in instances in which the second linked device supports EMLSR (e.g., using 2×2:2ss), the wireless device 700 may utilize EMLSR in conjunction with the second mode of operation, which may facilitate communications between the wireless device 700 and the second linked device while limiting interference between the communications via their respective spatial streams.

In some embodiments, the first linked device and the second linked device may be substantially similar to one another, which may include similar filters included therein. Alternatively, or additionally, the filters in the first linked device and the second linked device may be the same or similar as the filters 716 in the wireless device 700. For example, the first linked device may include multiple band pass filters configured to permit U-NII-5 through U-NII-8 frequencies and the second linked device may include multiple band pass filters configured to permit U-NII-5 through U-NII-8. In such instances, the wireless device 700 may be configured to communicate with the first linked device in a first portion of the filtered frequencies (e.g., the U-NII-5 and U-NII-6 bands) and with the second linked device in a second portion of the filtered frequencies (e.g., U-NII-7 and U-NII-8 bands), where each of the communications may be single band communications. By shifting the communications from the first mode of operation to the second mode of operation, the wireless device 700 may increase the throughput to the first linked device and the second linked device by concurrently communicating using the two bands.

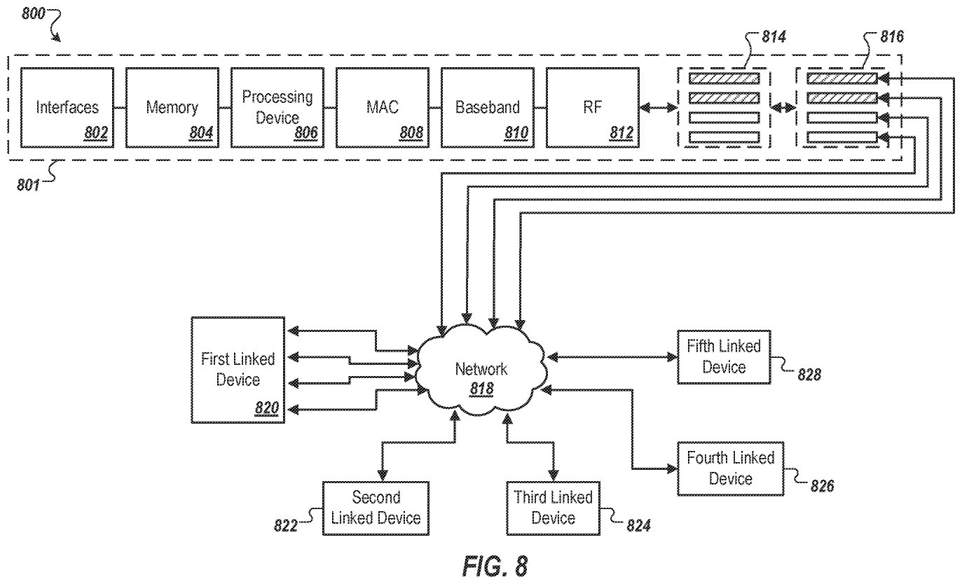

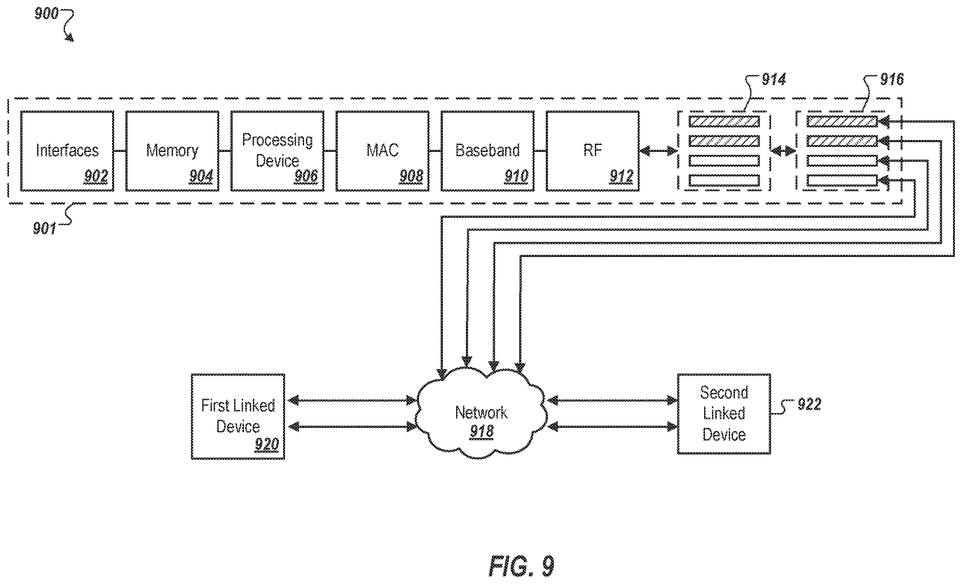

FIG. 8 and FIG. 9 illustrate an example environment 800 and an example environment 900, respectively, that support adaptive configurations between a wireless device and multiple linked devices, in accordance with at least one embodiment of the present disclosure. The environment 800 may include a wireless device 801, the network 818, the first linked device 820, a second linked device 822, a third linked device 824, a fourth linked device 826, and a fifth linked device 828. The wireless device 801 may include interfaces 802, a memory 804, a processing device 806, a MAC 808, a baseband component 810, an RF component 812, a FEM 814, and a filter 816. The environment 900 may include a wireless device 901, the network 918, the first linked device 920, and a second linked device 922. The wireless device 901 may include interfaces 902, a memory 904, a processing device 906, a MAC 908, a baseband component 910, an RF component 912, a FEM 914, and a filter 916.

The wireless device 801 and/or the wireless device 901 may be the same or similar as other wireless devices described herein, such as the wireless device 700a and 700b of FIGS. 7A and 7B, respectively, and may be configured to perform substantially all of the same operations as the described wireless devices. In some embodiments, the network 818 and/or the network 918 may be the same or similar as the network 140 of FIG. 1. In some embodiments, the first linked device 820 and/or the first linked device 920, the second linked device 822 and/or the second linked device 922, the third linked device 824, the fourth linked device 826, and/or the fifth linked device 828 may be the same or similar as one or more of the linked devices described herein, such as relative to FIGS. 7A and 7B.

In some embodiments, the environment 800 and/or the environment 900 may be a wireless environment (e.g., wireless devices and a wireless network) and the illustrated lines connecting the wireless device 801, the first linked device 820, the second linked device 822, the third linked device 824, the fourth linked device 826, and/or the fifth linked device 828 with the network 818 may be illustrative of spatial streams connecting the devices and not a wired connection. Further, the number of spatial streams associated with the first linked device 820, the second linked device 822, the third linked device 824, the fourth linked device 826, and/or the fifth linked device 828 may be illustrative only and the number of spatial streams supported by each linked device may be more or less than illustrated.

In general, FIG. 8 illustrates the different linked devices that the wireless device 801 may communicate with, including the number of spatial streams that may be used as part of the communications. For example, the wireless device 801 may use four spatial streams to communicate with the first linked device 820 (having four antennas) in the first mode of operation, such that high order MIMO operations may be utilized (e.g., 4×4:4ss) or the second mode of operation using multiple spatial streams over two different bands/channels, as described herein. Alternatively, or additionally, the wireless device 801 may use four single spatial streams to communicate individually with the second linked device 822, the third linked device 824, the fourth linked device 826, and/or the fifth linked device 828, each of which may be configured to use a single spatial stream (e.g., 1×1:1ss).

Similarly, FIG. 9 illustrates an instances in which the wireless device 901 may be configured to communicate with the first linked device 920 and/or the second linked device 922 using two sets of spatial streams, where both the first linked device 920 and the second linked device 922 may individually support two spatial streams using two antennas (e.g., 2×2:2ss). In some embodiments, the first linked device 920 and the second linked device 922 may be configured for single band/channel communications and/or dual band/channel communications, and the wireless device 901 may be configured to use the first mode of operation or the second mode of operation based on the characteristics of the first linked device 920 and/or the second linked device 922.

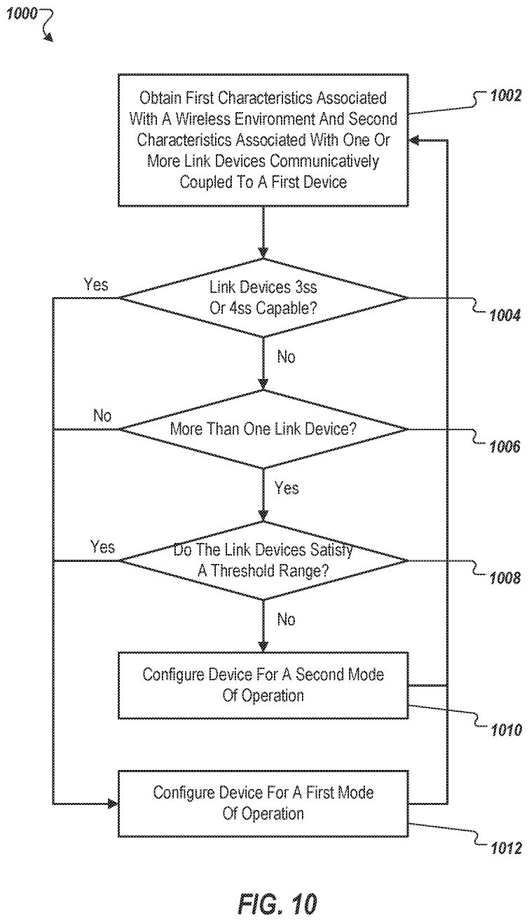

FIG. 10 illustrates a flowchart of an example method 1000 of determining a configuration for a wireless device in a wireless network, in accordance with at least one embodiment of the present disclosure. The method 1000 may be performed by processing logic that may include hardware (circuitry, dedicated logic, etc.), software (such as is run on a general purpose computer system or a dedicated machine), or a combination of both, which processing logic may be included in any computer system or device, such as the first device 110 of FIG. 1.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At block 1002, one or more characteristics associated with a wireless device and/or an environment (e.g., a wireless network) in which the wireless device is configured to operate, may be obtained. For example, a first characteristic may be associated with the wireless network and may include, but not be limited to, one or more of a density of devices in the wireless environment, a physical distance between the first device and the second device, a determined interference metric to signals in the wireless environment, and/or a predicted interference metric to signals in the wireless environment.

In another example, a second characteristic may be associated with one or more linked devices and may include, but not be limited to, one or more of a number of antenna associated with the linked devices, a number of supported spatial streams by the linked devices, an operational mode associated with the linked devices, or one or more device characteristics associated with the linked devices. In some embodiments, the one or more device characteristics may include one or more of a signal-to-noise ratio associated with communications between the wireless device and the linked devices, a received signal strength indicator associated with the communications between the wireless device and the linked devices, and/or a modulation coding scheme rate associated with the communications between the wireless device and the linked devices.

In some embodiments, the one or more characteristics may be obtained based on initial characteristics between the wireless device and the one or more linked devices and/or initial characteristics associated with the wireless network. Alternatively, or additionally, the one or more characteristics may be obtained during communications between the wireless device and the one or more linked devices. In some embodiments, the one or more characteristics may be obtained based on properties and/or other characteristics associated with other communications that may be transmitted between the wireless device and the one or more linked devices.

At block 1004, a determination of the number of spatial streams that may be supported by the one or more linked devices may be obtained. For example, a first linked device may support four spatial streams (4ss), a second linked device may support three spatial streams (3ss), and a third linked device may support two spatial streams (2ss). In instances in which a linked device is configured to support three or more spatial streams, the method 1000 may continue with block 1012. In instances in which a linked device is configured to support two or less spatial streams, the method 1000 may continue with block 1006. Using the previous example, the first linked device, and the second linked device may continue with block 1012 and the third linked device may continue with block 1006.

At block 1006, a determination of whether there are at least two linked devices that may be individually configured to support two spatial streams for communications. In instances in which there are two or more linked devices individually configured to support two spatial streams, the method 1000 may continue with block 1008. In instances in which there are not two or more linked devices individually configured to support two spatial streams (e.g., only one linked device is connected, or two linked devices are connected and only one linked device supports two spatial streams, etc.), the method 1000 may continue with block 1012.

At block 1008, a determination may be made as to whether the two or more two spatial stream capable linked devices (as determined at block 1006) satisfy a threshold physical distance from the wireless device. In some embodiments, the physical distance and/or the satisfaction of the threshold thereof may be determined using a determined RSSI associated with the linked devices and the wireless device relative to a threshold RSSI, a determined SNR associated with the linked devices and the wireless device relative to a threshold SNR, a determined MCS rate associated with the linked devices and the wireless device relative to a threshold MCS rate, and/or other determinations. In instances in which the linked device(s) are far away from the wireless device (e.g., one or more of the above-described thresholds are satisfied), the method 1000 may continue with block 1012. In instances in which the linked device(s) are not far away from the wireless device (e.g., one or more of the above-described threshold are not satisfied), the method 1000 may continue with block 1010.

At block 1010, the wireless device may be configured to operate in a second mode of operation. In some embodiments, the second mode of operation may include a dual band/channel concurrent communication between the wireless device and the two or more linked devices (e.g., capable of communicating with two spatial streams, 2×2:2ss). Once the wireless device is configured for the second mode of operations, the method of obtaining characteristics and performing subsequent determinations may be repeated to update the mode of operation associated with the wireless device as the network and/or linked devices may change in time.

At block 1012, the wireless device may be configured to operate in a first mode of operation. In some embodiments, the first mode of operation may include four antennas and four spatial streams (4×4:4ss) that may operate on a single band/channel. Once the wireless device is configured for the first mode of operations, the method of obtaining characteristics and performing subsequent determinations may be repeated to update the mode of operation associated with the wireless device as the network and/or linked devices may change in time.

Modifications, additions, or omissions may be made to the method 1000 without departing from the scope of the present disclosure. For example, the designations of different elements in the manner described is meant to help explain concepts described herein and is not limiting. Further, the method 1000 may include any number of other elements or may be implemented within other systems or contexts than those described.

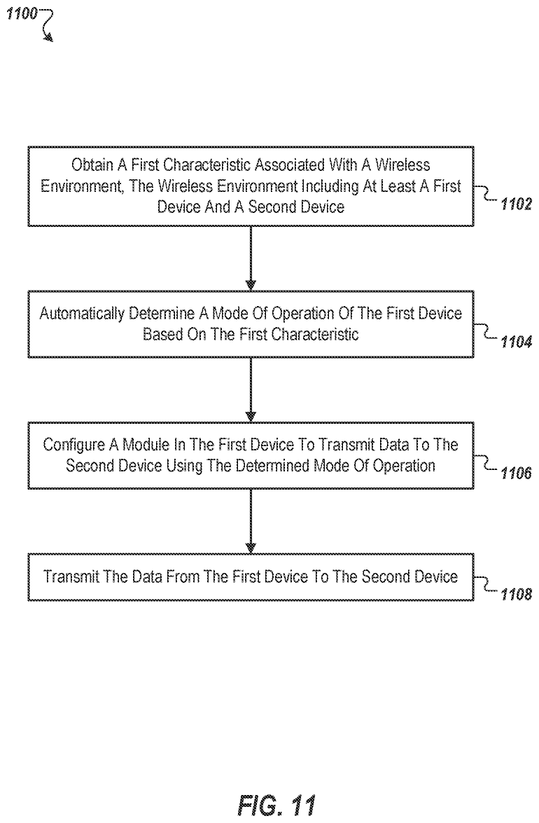

FIG. 11 illustrates a flowchart of an example method 1100 of adaptive configurations in a wireless network, in accordance with at least one embodiment of the present disclosure. The method 1100 may be performed by processing logic that may include hardware (circuitry, dedicated logic, etc.), software (such as is run on a general-purpose computer system or a dedicated machine), or a combination of both, which processing logic may be included in any computer system or device such as the first device 110 of FIG. 1.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At block 1102, a first characteristic associated with a wireless environment may be obtained. In some embodiments, the wireless environment may include at least a first device and a second device. Alternatively, or additionally, a second characteristic associated with the second device may be obtained.

In some embodiments, the first characteristic may include one or more of a density of devices in the wireless environment, a physical distance between the first device and the second device, a determined interference metric to signals in the wireless environment, and/or a predicted interference metric to signals in the wireless environment. In some embodiments, the second characteristic may include one or more of a number of antenna associated with the second device, a number of supported spatial streams by the second device, an operational mode associated with the second device, and/or one or more device characteristics associated with the second device.

In some embodiments, the device characteristics may include one or more of a signal-to-noise ratio associated with communications between the first device and the second device, a received signal strength indicator associated with the communications between the first device and the second device, and a modulation coding scheme rate associated with the communications between the first device and the second device.

At block 1104, a mode of operation of the first device may be automatically determined. In some embodiments, the mode of operation may be determined based on the first characteristic. In some embodiments, the mode of operation of the first device may be automatically adjusted based on the second characteristic.

In some embodiments, the mode of operation may include a first mode of operation and a second mode of operation. The first mode of operation may include configuring four antennas and four spatial streams of the first device for communications using a single frequency band or a single frequency channel. The second mode of operation may include configuring at least two antennas and two spatial streams of the first device for communications using multi-band or multi-channel concurrent communications.

At block 1106, an adaptive module in the first device may be configured to transmit data to a second device using the determined mode of operation. In instances in which the second characteristic is obtained, the adaptive module in the first device may be configured to transmit the data to the second device using the adjusted mode of operation.

In some embodiments, the data may be transmitted from the first device to the second device using a first filter and/or second data may be transmitted from the first device to a third device using a second filter. In some embodiments, the data and the second data may be transmitted concurrently and/or may be separated using a channel avoidance algorithm.

At block 1108, data from the first device may be transmitted to the second device using the adaptive module and the determined mode of operation. In instances in which the second characteristic is obtained, the data may be transmitted from the first device to the second device using the adaptive module and the adjusted mode of operation.

Modifications, additions, or omissions may be made to the method 1100 without departing from the scope of the present disclosure. For example, the designations of different elements in the manner described is meant to help explain concepts described herein and is not limiting. Further, the method 1100 may include any number of other elements or may be implemented within other systems or contexts than those described.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although implementations of the present disclosure have been described in detail, various changes, substitutions, and alterations could be made hereto without departing from the spirit and scope of the present disclosure.

What is claimed is:

1. A method, comprising:
obtaining a first characteristic associated with a wireless environment, the wireless environment including at least a first device and a second device;
automatically determining a mode of operation of the first device based on the first characteristic;
configuring an adaptive module in the first device to transmit data to the second device using the determined mode of operation; and
transmitting the data from the first device to the second device using the adaptive module and the determined mode of operation.

2. The method of claim 1, wherein the first characteristic comprises one or more of a density of devices in the wireless environment, a physical distance between the first device and the second device, a determined interference metric to signals in the wireless environment, or a predicted interference metric to signals in the wireless environment.

3. The method of claim 1, further comprising:
obtaining a second characteristic associated with the second device;
automatically adjusting the mode of operation of the first device based on the second characteristic;
configuring the adaptive module in the first device to transmit the data to the second device using the adjusted mode of operation; and
transmitting the data from the first device to the second device using the adaptive module and the adjusted mode of operation.

4. The method of claim 3, wherein the second characteristic comprises one or more of a number of antenna associated with the second device, a number of supported spatial streams by the second device, an operational mode associated with the second device, or one or more device characteristics associated with the second device.

5. The method of claim 4, wherein the one or more device characteristics comprises one or more of a signal-to-noise ratio associated with communications between the first device and the second device, a received signal strength indicator associated with the communications between the first device and the second device, and a modulation coding scheme rate associated with the communications between the first device and the second device.

6. The method of claim 1, wherein the mode of operation comprises a first mode of operation and a second mode of operation.

7. The method of claim 6, wherein the first mode of operation comprises configuring four antennas and four spatial streams of the first device for communications using a single frequency band or a single frequency channel.

8. The method of claim 6, wherein the second mode of operation comprises configuring at least two antennas and two spatial streams of the first device for communications using multi-band or multi-channel concurrent communications.

9. The method of claim 1, wherein the data is filtered and transmitted from the first device to the second device using a first filter and second data is filtered and transmitted from the first device to a third device using a second filter.

10. The method of claim 9, wherein the data and the second data are transmitted concurrently and are separated using a channel avoidance algorithm.

11. A wireless device, comprising:
an adaptive module; and
a processing device configured to execute instructions, that when executed cause the processing device to perform operations comprising:
automatically determine a mode of operation of the wireless device in response to obtaining a first characteristic associated with a wireless environment;
direct a configuration of the adaptive module to transmit data to a second device using the determined mode of operation; and
direct a transmission of the data to the second device using the adaptive module and the determined mode of operation.

12. The wireless device of claim 11, further comprising:
a first front end module corresponding to a first spatial stream associated with a first band, the first front end module to process a first signal included in the first band transmitted or received by the adaptive module; and
a second front end module corresponding to a second spatial stream associated with a second band, the second front end module to process a second signal included in the second band transmitted or received by the adaptive module.

13. The wireless device of claim 11, further comprising:
a first filter to filter the data on a first spatial stream transmitted or received by the adaptive module; and
a second filter to filter a second data on a second spatial stream transmitted or received by the adaptive module,
wherein the data and the second data are transmitted concurrently and are separated using a channel avoidance algorithm.

14. The wireless device of claim 11, wherein the first characteristic comprises one or more of a density of devices in the wireless environment, a physical distance between the wireless device and the second device, a determined interference metric to signals in the wireless environment, or a predicted interference metric to signals in the wireless environment.

15. The wireless device of claim 11, wherein the operation performed by the processing device further comprise:
obtaining a second characteristic associated with the second device;
automatically adjusting the mode of operation of the wireless device based on the second characteristic;
configuring the adaptive module in the wireless device to transmit the data to the second device using the adjusted mode of operation; and
transmitting the data from the wireless device to the second device using the adaptive module and the adjusted mode of operation.

16. The wireless device of claim 15, wherein the second characteristic comprises one or more of a number of antenna associated with the second device, a number of supported spatial streams by the second device, an operational mode associated with the second device, or one or more device characteristics associated with the second device.

17. The wireless device of claim 16, wherein the one or more device characteristics comprises one or more of a signal-to-noise ratio associated with communications between the wireless device and the second device, a received signal strength indicator associated with the communications between the wireless device and the second device, and a modulation coding scheme rate associated with the communications between the wireless device and the second device.

18. The wireless device of claim 11, wherein the mode of operation comprises a first mode of operation and a second mode of operation.

19. The wireless device of claim 18, wherein the first mode of operation comprises configuring four antennas and four spatial streams of the wireless device for communications using a single frequency band or a single frequency channel.

20. The wireless device of claim 18, wherein the second mode of operation comprises configuring at least two antennas and two spatial streams of the wireless device for communications using multi-band or multi-channel concurrent communications.
